(19) United States
(12) Patent Application Publication
(10) Pub. No.: US 2026/0311053 A1
(43) Pub. Date: Oct. 8, 2026

(54) METHOD AND APPARATUS TO ENABLE FEDERATED LEARNING JOB MANAGEMENT SERVICES

(71) Applicant: InterDigital Patent Holdings, Inc., Wilmington, DE (US)

(72) Inventors: Dale Seed, Allentown, PA (US); William Robert Flynn, IV, Schwenksville, PA (US); Quang Ly, North Wales, PA (US); Lu Liu, Conshohocken, PA (US)

(73) Assignee: InterDigital Patent Holdings, Inc., Wilmington, DE (US)

(21) Appl. No.: 19/483,106

(22) PCT Filed: Jun. 7, 2024
(86) PCT No.: PCT/US2024/032934

§ 371 Date: Nov. 10, 2025

Related U.S. Application Data
(60) Provisional application No. 63/507,131, filed on Jun. 9, 2023.

(51) Int. Cl. G06N 20/00

(52) U.S. Cl. CPC G06N 20/00

(57) ABSTRACT

Federated learning (FL) may be deployed as a service via the definition of FL job management functionality. An FL service may have the capability to receive FL job specifications from FL users, process and manage these FL jobs on behalf of FL users via interaction with FL clients, and update FL users with the status of FL jobs as they are being processed.

### CROSS-REFERENCE TO RELATED APPLICATIONS

This application claims the benefit of U.S. Provisional Patent Application No. 63/507,131, filed Jun. 9, 2023, which is hereby incorporated by reference in its entirety.

### BACKGROUND

Federated learning (FL) is an approach to machine learning in which an FL server manages the training of a machine learning model through the utilization of multiple FL clients. Data privacy is an important aspect of federated learning and therefore data is kept locally at the individual clients. As a result, data confidentiality is preserved at the individual clients, but the desired machine learning application may still be achieved through the training of a model with the federated learning clients. FL training is performed through multiple rounds in which the ML model, model parameters, and associated training parameters are communicated from the FL server to the FL clients at the beginning of each round and the FL clients provide the model update (including updated model parameters) to the FL server after training has completed for the round. The FL server aggregates the model parameters, updates the global model, and the training repeats for the next round with the model updates.

### SUMMARY

Disclosed herein are methods and apparatus to enable federated learning (FL) to be deployed as a service via the definition of FL job management functionality. Disclosed are methods and apparatus to enable a FL service with the capability to receive FL job specifications from FL users, process and manage these FL jobs on behalf of FL users via interaction with FL clients, and update FL users with the status of FL jobs as they are being processed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 shows an example of an FL training round;

FIG. 2 shows an example FL job service overview;

FIG. 3 shows an example FL job specification procedure;

FIG. 4 shows an example FL job management procedure;

FIG. 5 shows an example FL job status procedure;

FIG. 6 shows an example FL job end-to-end embodiment;

FIG. 7 shows an example FL job graphical user interface (GUI) embodiment;

FIG. 8A illustrates an example communications system;

FIGS. 8B, 8C, and 8D are system diagrams of example RANs and core networks;

FIG. 8E illustrates another example communications system;

FIG. 8F is a block diagram of an example apparatus or device, such as a WTRU; and

FIG. 8G is a block diagram of an exemplary computing system.

### DETAILED DESCRIPTION

The following acronyms have the following meanings throughout:
3GPP Third Generation Partnership Project
5GS 5G System
API Application Programming Interface
CSP Cloud Service Provider
FL Federated Learning
ML Machine Learning

The following terms may have the following meanings:

The term “federated learning user (FL user)” may refer to a user apparatus (e.g., computer, smart phone, tablet) hosting compute, memory and network connectivity resources capable of hosting a user application software (e.g., web browser, app) which a user uses to perform FL centric operations with a FL service. One such type of operation defined in the context of this disclosure involves the FL user configuring a FL service with a FL job to perform on the FL user's behalf.

The term “federated learning client (FL client)” may refer to a network apparatus (e.g., device, gateway or server) hosting compute, memory and network connectivity resources capable of hosting a FL client software (e.g., FL client application) and local data which the FL client uses to perform operations such as training a ML model in a federated manner.

The term “federated learning service (FL service)” may refer to a network apparatus (e.g., device, gateway or server) hosting compute, memory and network connectivity resources capable of hosting FL service software which performs FL management operations such as receiving a FL job which the FL server uses to train a ML model in a federated manner across FL clients.

The term “federated learning job (FL job)” may refer to a set of FL user defined instructions and requirements for training a ML model in a federated manner. A FL user configures a FL service with an FL job to enable the FL service to offload and train an ML model in a federated manner on behalf of the FL user.

The term “federated learning training round (FL round)” may refer to one iteration of training performed on a ML model in a federated manner by FL clients wherein the training is managed by a FL service.

The term “federated learning task (FL task)” may refer to a set of instructions and requirements sent by a FL service to multiple FL clients for training a ML model in a federated manner. A FL task contains client specific configurations needed to train a ML model to meet the conditions specified by a FL job. A FL task may be generated by the FL service for each round of federated training that is performed on an ML model. A FL task may be specified by a FL user or a FL service.

FL is an approach to machine learning in which an FL server manages the training of a machine learning model through the utilization of multiple FL clients. Data privacy is an important aspect of federated learning and therefore data is kept locally at the individual clients. As a result, data confidentiality is preserved at the individual clients, but the desired machine learning application may still be achieved through the training of a model with the federated learning clients. FL training is performed through multiple rounds in which the ML model, model parameters, and associated training parameters are communicated from the FL server to the FL clients at the beginning of each round and the FL clients provide the model update (including updated model parameters) to the FL server after training has completed for the round. The FL server aggregates the model parameters, updates the global model, and the training repeats for the next round with the model updates.

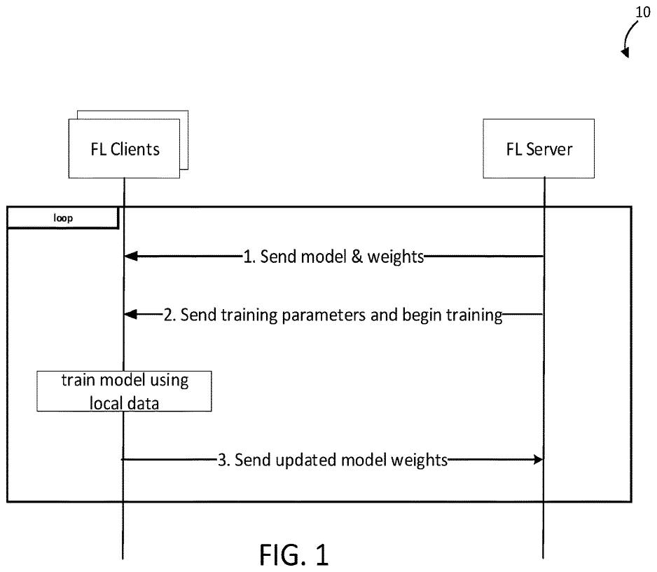

FIG. 1 shows an example 10 of a federated learning training round between an FL server and multiple FL clients. In each training round, a FL server provides an ML model to each FL client accompanied with the associated model parameters and training parameters. The FL clients train the ML model with local data and send the updated model parameters to the FL server for aggregation. The training repeats until the performance objectives are met.

For example, at step 1, the FL server may send a model and weights to one or more FL clients. At step 2, the FL server may send training parameters to the one or more FL clients and begin training the one or more FL clients. At step 3, the one or more FL clients may send updated model weights to the FL server.

In federated learning, FL users and FL clients are decoupled from each other and may not even have direct communications with each other. The FL user is the domain expert for the ML application and has in-depth knowledge of the requirements of the ML algorithm but does not have access to the data that will be used for training the ML algorithm. FL clients, on the other hand, have data that are used to train the ML algorithm but are not able to manage training the ML algorithm for the duration for the federated learning process. A FL client may not know of the presence of other FL clients and may not be able to receive the requirements from FL users due to the aforementioned decoupling of FL user to FL clients.

Disclosed herein are methods and apparatus to enable federated learning (FL) to be deployed as a service via the definition of FL job management functionality. Disclosed are methods and apparatus to enable a FL service with the capability to receive FL job specifications from FL users, process and manage these FL jobs on behalf of FL users via interaction with FL clients, and update FL users with the status of FL jobs as they are being processed.

Specifically, an FL service is disclosed that is capable of:
receiving a FL job creation or update request from a FL user with FL job information comprising one or more of the following types of information elements:
   starting and stopping conditions of the FL job
   a priority of the FL job
   a type of ML model that is to be trained in a federated manner
   a type of problem, such as object classification, such that the FL service may be able to determine one or more candidate machine learning algorithms to create “experiments”.
   the type of data that the FL clients should use for the FL training rounds.
   a multi-model training mode indication
   hyperparameter settings
   functions or scripts to evaluate model performance
   FL training environment requirements such as min number of training rounds, FL clients, data instances
   FL client configuration requirements for training the ML algorithm (e.g., required operating environment, the FL framework, algorithm name and version, runtime requirements, processor and memory requirements, minimum number of sample data, and max age of data)
based on the received FL job information, performing one or more of the following operations:
   determining if the FL user has FL job privileges and is authorized to perform the FL job
   storing the FL job information such that the FL service can access and use the information while performing the FL job
   selecting FL clients that meet the FL training requirement of the FL job
   determining one or more FL tasks to delegate to the FL clients to perform in order to train the ML model in a federated manner
   determining if/when to start a FL job
sending a FL job creation/update response back to the FL user comprising information such as a FL job ID and an FL job status
sending FL task requests to FL clients comprising FL task information comprising one or more of the following types of information:
   an ID of the FL task and/or ID of an FL job that the task is associated with
   a priority of the FL task
   a FL round number associated with the FL task
   FL task starting or stopping conditions
   FL task functions
   required FL client configuration settings the FL client is to use in order to meet the training requirements.
   ML algorithm and corresponding version and initial model parameters
   hyperparameters for the ML training process
   data filters
sending FL task subscription or retrieve requests to FL clients to obtain FL task results and status information
receiving FL task results and status information from FL clients comprising information such as:
   A change in FL task status (e.g., started, paused, resumed, cancelled, completed)
   A training/performance threshold of a ML model having reached a certain level
   A change in FL client status (e.g., availability, error condition, FL task completed)
   updated model parameters
   model training results (e.g., model accuracy and performance results).
based on the information received from the FL clients, determining whether to perform additional FL training rounds by aggregating information and comparing it against ML requirements specified in the FL job by the FL users
receiving a FL job subscription or retrieval request from FL users to obtain FL job results and status information of interest to the FL users
sending FL job results and status information to the FL users comprising one or more of the following types of information:
   A change in FL job status (e.g., started, paused, resumed, cancelled, completed)
   An indication that a training/performance threshold of a ML model has reached a certain level
   A change in FL client status (e.g., availability, error condition, FL task completed)

As described herein, a FL service may assist a FL user with training a machine learning model in a federated manner using FL clients in the network hosting local data which must remain local (e.g., for privacy or ownership reasons). The FL service may offer interfaces and corresponding services to both FL users and FL clients. Via the FL user interface, the FL user may configure the FL service with a FL job. A FL job may comprise user defined instructions and requirements which the FL service may use to manage the training of a ML model in a federated manner in a service based manner on behalf of the FL user. The FL user interface may also support the capability for the FL user to check the status of the FL job and if necessary, modify the configuration of the FL job while it is being processed by the FL service. To execute a FL job, a FL service may interface to FL clients and direct these FL clients to perform federated training operations. When interfacing to FL clients, the FL service may configure the FL clients with FL tasks. A FL task may be comprised of a set of configurations and/or instructions a FL client uses to train an ML model in a federated manner. Federated training may involve multiple rounds of training where the FL clients perform ML model training operations, sharing the training results with the FL service, receiving an updated ML model from the FL service, and then performing additional training rounds thereafter. The rounds of training may continue until the FL service determines a required level of training of the ML model has been reached (e.g., a certain model precision is reached as defined by the FL user within the FL job). A FL task which the FL server shares with the FL clients may be specified at the granularity of an individual FL training round or at the granularity of multiple training rounds.

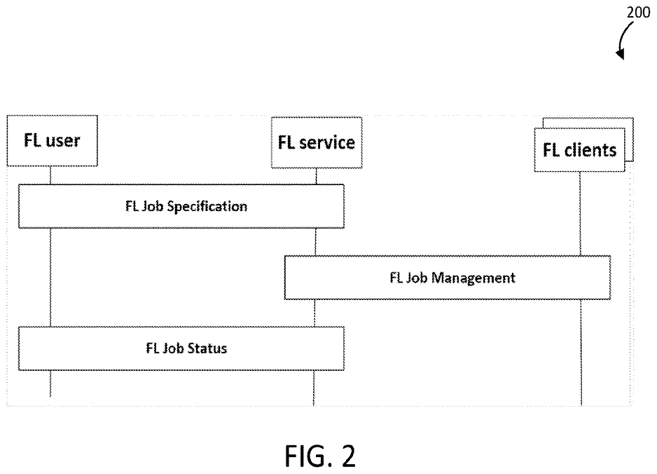

FIG. 2 provides a high level example 200 showing the various procedures involved with a FL user configuring a FL service with a FL job: job specification, job management, and job status procedures. Using information defined within the FL job, the FL service may coordinate FL training rounds with FL clients in order to train a ML model in a federated manner which meets the requirements of the FL user. The FL service may provide FL job status information to the FL user for the duration of the FL job. As a result, the FL user may monitor the progress of a FL job and/or take action such as updating a FL job to inform the FL service of changes to the FL job.

Specifying a FL job involves a FL user providing requirements for an ML application to a FL service. As part of the requirements, the FL user may specify the need to utilize federated learning to train a particular algorithm with data that may be available at FL clients. The FL service can use the requirements provided by the FL user to manage operations in training a machine learning model in a federated manner across a set of FL clients. The information specified by a FL job may comprise various elements. For example, one or more machine learning algorithms or models, hyperparameters for the associated models, and stopping criteria that define when a model is sufficiently trained.

In an example, an apparatus associated with an FL service may receive, from an FL user, a request to create or update an FL job. The request may comprise FL job information indicating one or more machine learning (ML) requirements and one or more FL training requirements. The one or more ML requirements may indicate at least one of: one or more ML algorithms, an ML problem type, a multi-model training mode, one or more hyperparameters, a model evaluation function, model initialization, an aggregation algorithm, a minimum number of FL training rounds, a minimum number of FL clients, or a minimum number of total data instances. The one or more FL training requirements may comprise at least one of a specified operating environment, an FL framework, an algorithm name and version, one or more runtime requirements, one or more processor and memory requirements, a minimum number of sample data, or a maximum age of data. The FL job information may further indicate an FL client configuration indicating at least one of: an FL client ID list, one or more FL client training requirements, or an FL client data filter Based on the FL job information, the apparatus may perform at least one of: determining whether the FL user is authorized to perform the FL job, selecting one or more FL clients that meet one or more FL training requirements, or determining one or more FL tasks, associated with the FL job, to be performed by the one or more FL clients. The apparatus may send, to the FL user, a response comprising a FL job ID and FL request status information. The apparatus may send, to the one or more FL clients, one or more FL task requests comprising FL task information. The apparatus may receive, from the one or more FL clients, FL task status information. The apparatus may, based on the received FL task status information, determine whether to perform one or more FL training rounds. The determination whether to perform one or more FL training rounds may be based on aggregating the received FL task status information and comparing it to ML requirements specified in the FL job by the FL user. The apparatus may send, to the FL user, FL job status information. The FL job status information may indicate at least one of: a status indicating whether the FL job has not started, has started, has paused, has resumed, has stopped, has been cancelled, has completed, or a current FL round number.

In another example, an apparatus associated with an FL may receive, from an FL service, one or more FL task requests comprising FL task information, wherein the FL task information indicates one or more machine learning (ML) requirements and one or more FL training requirements. The apparatus may perform, based on the one or more FL task requests, one or more FL tasks. The apparatus may send, to the FL service, one or more notifications comprising FL task status information.

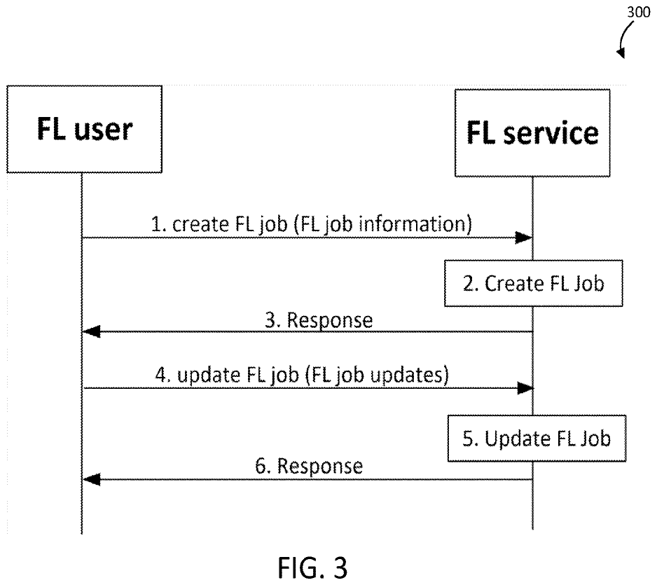

FIG. 3 shows an example 300 FL job specification procedure comprising creation and update of a FL job initiated by a FL user to a FL service. A FL job may be created to start training a ML model in a federated manner and the FL user may also update the FL job to provide the FL service with additional FL job information.

At step 1, a FL user may issue one or more requests to a FL service to create and configure a FL job. Within the one or more requests, the FL user may specify FL job information such as but not limited to the information defined in Table 1. Note that the FL user may only be able to provide configuration information listed in Table 1 and not other information that the FL service may provide back to the FL user, e.g., FL job status, FL job results, and FL client ID list. For example, the request(s) may include the type of model that is to be trained in a federated manner along with the performance criteria for determining when to stop training. The request(s) may also include the type of problem, such as object classification, such that the FL service may be able to determine one or more candidate machine learning algorithms to create “experiments”. The request(s) may also include the type of data that the FL clients should use for the FL training rounds. For example, if a FL client has images of cars, trucks, and motorcycles, the FL user may specify that only motorcycle images are needed for training. The request(s) may also include FL client requirements for training the ML algorithm. Examples of training requirements for the FL clients may be the required operating environment, the FL framework, algorithm name and version, runtime requirements, processor and memory requirements, minimum number of sample data, and max age of data. Other high level FL configurations such as minimum number of training rounds, minimum number of FL clients (for each training round and for the entire FL process), and minimum number of total data instances may also be provided by the FL user.

TABLE 1
FL Job Information

| Informational | |
|---|---|
| Element | Description |
| FL job ID | A unique identifier that the FL service assigns |
| | to the FL job when processing the FL job creation |
| | request. Thi sidentifier is provided to the FL |
| | user in the response to a FL create request. |
| | This identifier can be used in subsequent requests |
| | the FL user issues to the FL service to update, |
| | subscribe, retrieve, or delete the FL job. |
| FL job starting | Conditions defining if/when the FL service should |
| conditions | start processing the FL job and perform the |
| | federated training. Examples of conditions may |
| | include an indication to start immediately |
| | (upon creation of the FL job), start at a |
| | specified relative time (in 1 hour) or absolute |
| | time (March 10 at 2pm), start upon detection of |
| | a specified event condition such as when one or |
| | more FL clients are available or have necessary |
| | resources (e.g., CPU, memory, battery) available. |
| | This parameter may consist of more than one |
| | condition. |
| FL job stopping | Conditions defining when the FL service should |
| conditions | stop the processing of the FL job. Examples of |
| | conditions may include an achieved ML model |
| | accuracy or performance, a training time limit, |
| | a percentage of training completed, or a number |
| | of training rounds completed. |
| FL job control | Once a FL job is created, a FL user may update this |
| | information element to trigger the FL service to |
| | start, pause, re-start, or stop/cancel the |
| | processing of an FL job. |
| FL job priority | A priority may be defined for a FL job. This priority |
| | may be used by the FL service to prioritize the |
| | processing and execution of a FL job. For example, |
| | if multiple FL jobs need to be performed and there |
| | are limited FL service and/or FL client resources |
| | available, this priority may be used by the FL |
| | service to determine an order in which to perform |
| | FL jobs. |
| FL job status | FL job status information which the FL service |
| | makes available during the processing of the FL |
| | job. Examples of FL job status information may |
| | include a status indicating whether the FL job |
| | is pending and not started yet, started, paused, |
| | resumed, stopped/cancelled, completed. The FL |
| | job status may also include additional information |
| | such as the current FL round number. |
| FL job results | The results from the FL job. Example of results may |
| | include an indicator whether the FL job completed |
| | successfully or an error code, an achieved level of |
| | model accuracy or performance, a trained model |
| | and/or model parameters, an elapsed time of the |
| | training, the number of FL clients participating |
| | in the training process, the aggregated number of |
| | data instances used for the training, etc. For |
| | cases in which multiple ML algorithms/models |
| | were trained, the status may indicate individual |
| | status for each algorithm/model and rank them |
| | according to some ranking criteria. |
| machine learning | One or more machine learning algorithms the FL |
| algorithms | service will configure FL clients to use to train |
| | a model using the data maintained by the FL |
| | clients. The algorithms may be provided by the |
| | FL user or selected by the FL service. |
| problem type | A type of machine learning problem. The FL service |
| | may use the specified problem type to select |
| | appropriate machine learning algorithms or FL |
| | clients for training. |
| multi-model | If more than one machine learning model candidates |
| training mode | are to be trained, the FL user may indicate if |
| | the models can be trained in parallel or series. |
| | If trained in parallel, each FL client may only |
| | train one or some of the model candidates in |
| | each round. It should be noted that the FL clients |
| | used for training are not required to be the same |
| | for each model. |
| | If trained in series, each FL client may train all |
| | the model candidates in each round. Each model |
| | may be trained using the same FL client and |
| | same data set. |
| Hyperparameters | Hyperparameters settings such as train vs test vs |
| | validation partitioning, number of epochs or |
| | iterations, batch sizes, etc. configured for the |
| | training. |
| model evaluation | Functions or scripts that may be run to evaluate |
| functions | model performance between rounds. These can be |
| | run on FL clients or by the FL service (or both). |
| | These can be preconfigured by the FL service or |
| | supplied by the FL user, for example as a script. |
| FL training | Requirements specified by the FL user which must |
| requirements | be met when the FL service is performing the FL |
| | training operations. Examples of requirements |
| | may include a specified operating environment, |
| | FL framework, algorithm name and version, runtime |
| | requirements, processor and memory requirements, |
| | min number of sample data, max age of data. |
| model | An initial global model (and/or its location) or |
| initialization | initial model parameters or weights that the FL |
| | user specifies to the FL service. |
| aggregation | An aggregation algorithm to be used by the FL |
| algorithm | service to combine the model parameters collected |
| | from FL clients. If not specified, the FL service |
| | may apply a default algorithm for aggregation. |
| | Alternatively or additionally, the information |
| | of an aggregator may be specified, such as the |
| | identifier or location/address of the aggregator |
| | where the trained model parameters from a round |
| | of FL training should be sent to. |
| minimum number of | A minimum number of training rounds required for |
| training rounds | training the ML model |
| minimum number of | A minimum number of FL clients that is required to |
| FL clients | partake in the federated training, for each round |
| | and for the duration of the FL training |
| minimum number of | A minimum number of data instances used to train |
| total data instances | the ML model in a federated manner. The total |
| | number of instances should be aggregated from |
| | all FL clients contributing to the FL training. |
| FL client | A FL client configuration may include one or more |
| configuration: | of the following sub-elements: |
| >FL client ID List | List of Identifiers of the FL clients that this |
| | configuration applies to. This list may be optional |
| | as in some cases, the FL user may not have |
| | information about the FL clients for privacy |
| | purposes. |
| >FL client training | Required FL operating environment, FL framework, |
| requirements | algorithm name and version, runtime requirements, |
| | processor and memory requirements, min number of |
| | sample data, max age of data, data have been |
| | prepared, |
| >FL client data filter | This is used to limit the data that the FL client uses |
| | for training. Examples include, but are not limited |
| | to, limits based on a time window or feature values. |

At step 2, upon receiving the request, the FL service may check that the FL client is authorized to access the FL service and create the FL job. To perform this check, the FL service may check whether the FL user has FL job creation privileges defined within an access control policy of the FL service. In addition, the FL service may also check one or more individual information elements configured in the FL job request to determine whether the FL user has necessary privileges. For example, whether the FL user has privileges to perform FL training operations on the specified FL clients, or privileges to access and use the specified ML algorithms. If authorization is successful, the FL service may create the FL job by storing the FL job information defined in Table 1 such that it can be accessed by the FL service. The FL job information may be stored locally at the FL service, or it may be stored in another service (e.g., storage service) which the FL service may interconnect with. In addition, the FL service may determine if it needs to perform any FL job centric operations such as start the processing of the FL job. This determination may be made using the specified FL job start conditions.

The FL service may also use the FL job information received from the FL user to determine and select FL clients that can provide the required dataset for FL training. The FL job information may require the FL service to select a minimum number of FL clients and determine if the aggregate data instances from all the FL clients fulfill the minimum number of data instances for the individual FL client and for the entire FL process.

At step 3, the FL service may send a response back to the FL user. The response may comprise one or more information elements defined in Table 1. For example, the FL service may have assigned a FL job ID and include the identifier in the response. The response may also comprise additional information such as a status code indicating whether or not the FL job was created or not. If the FL service was unable to create the FL job, an error code may accompany the status of the response to indicate why the FL service was unable to create the FL job. Examples of error codes may include: insufficient FL clients found, insufficient number data instances found, ML algorithm not available, aggregation algorithm not available, maximum age of data is exceeded, etc.

In step 4, once a FL job is created, a FL user may send a subsequent request to the FL service to update the FL job. The update request may comprise one or more information elements such as but not limited to those defined in Table 1. For example, in the event that the user does not define FL job start conditions when creating the FL job, the FL user may send a FL job update request to manually trigger the FL service to start the FL job (e.g., via configuring the FL job control information element) associated with a FL job ID. In another example, the FL user may determine during the FL training process that parameters of the FL job or FL tasks require modification (e.g., select or unselect certain FL clients, update stopping criteria, change ML algorithm/model, etc.).

At step 5, upon receiving FL job update request, the FL service may check that the FL job ID references a valid FL job and that the FL user is authorized to access the FL service and update this FL job. To perform this check, the FL service may use similar checks as defined in Step 2. If authorization is successful, the FL service may update the FL job by updating the FL job information with the one or more information elements specified in the request. In addition, the FL service may determine if any FL job centric operations need to be performed such as start, pause, re-start or stop the processing of the FL job.

At step 6, the FL service may send a response back to the FL user. The response may comprise one or more information elements defined in Table 1. For example, the response may comprise information elements which were successfully updated along with their values. The response may also comprise additional information such as a status code indicating whether or not the FL job was updated or not.

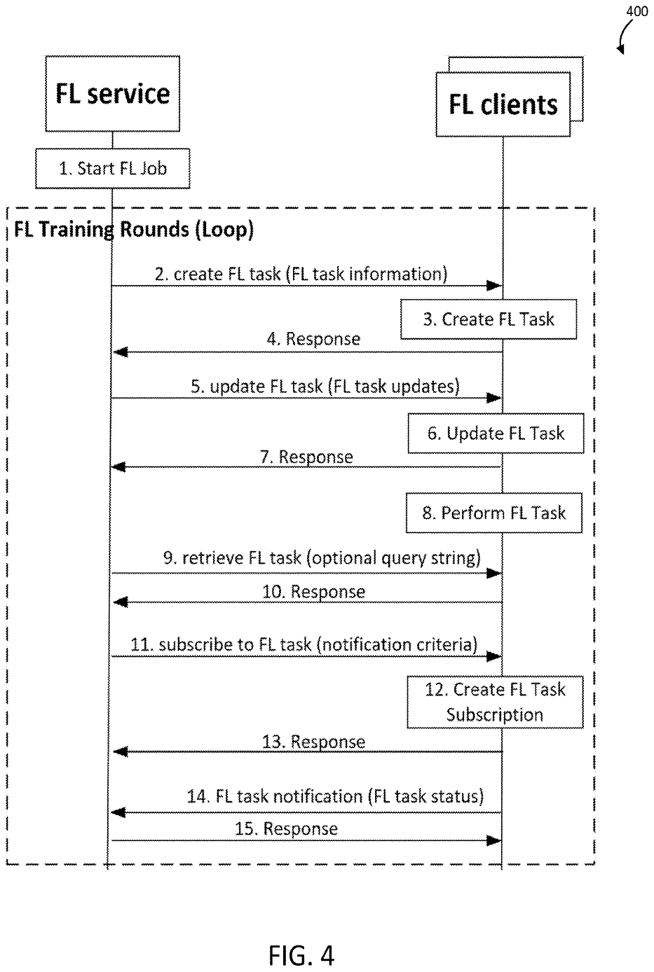

FIG. 4 shows an example FL job management procedure 400. Once a FL service is configured with an FL job by a FL user, the FL service may process and manage the FL job on behalf of the FL user. During the processing of the FL job, the FL service may perform one or more operations such as but not limited to the operations defined in FIG. 4. For example, the FL service may determine if/when to start, pause, re-start and end a FL job. The FL service may determine one or more ML algorithms/models to train in a federated manner, the hyperparameters to use, FL clients to perform the FL training, and the individual FL tasks which the FL service configures the individual FL clients to perform the training.

At step 1, based on information configured within the specified FL job, the FL service may determine if/when to start a FL job. For example, the FL service may monitor if/when the conditions specified in the “FL job start conditions” information element defined in Table 1 such as a specified relative, an absolute time value, or specified conditional expressions. A conditional expression may comprise one or more conditions which the FL service monitors. The conditions may comprise names and/or references to resources accessible to the FL service such as a URI to a resource of the FL service (e.g., a FL client digital twin resource). The conditions may also comprise operators (e.g., <, >, =, <=, =>) and comparison values such as a threshold value. Alternatively, the FL service may receive an explicit request from a FL user to trigger the FL service to start a FL job. For example, the FL service may receive a request to update the “FL job control” information element defined in Table 1 which triggers the FL service to start the FL job.

At step 2, the FL service may send requests to FL clients to create FL tasks which are used to coordinate and manage the training of the ML algorithm(s)/model(s) in a federated manner. The FL service may create one or more FL tasks on each FL client. Each FL task may comprise information such as but not limited to the information elements defined in Table 2. For example, a FL task may comprise required FL client configuration settings the FL client is to use in order to meet the training requirements. Some example settings may include FL Client Configuration, the ML algorithm and corresponding version, initial model parameters, and hyperparameters for the ML training process. To determine the information to include in a given FL task for a given FL client, the FL service may rely on information specified by a FL user in the FL job information defined in Table 1, information from other sources such as pre-provisioned FL service policies or interaction that the FL service performs with other services in the system, and/or information about the FL clients that the FL service has obtained and/or is provisioned with. The FL service may configure FL clients with FL tasks at different times during the processing of a FL job. For example, the FL service may perform multiple rounds of federated training to train a ML algorithm/model in a federated manner. At the start of each federated training round, the FL service may send a request to each FL client to create a FL task for the FL client to perform in that round.

An alternative to the FL service sending requests to the FL clients to create FL tasks is for the FL service to instead add FL tasks to FL client task queues which are stored and maintained by the FL service (not shown in FIG. 4). FL clients may subscribe to these FL client task queues maintained by the FL service. When new FL tasks are added to a queue, the FL service may send a notification to the respective FL client. A notification may comprise FL task information. The FL client may return a response to the FL service to acknowledge receiving the FL task information. The response may comprise information such as an estimate of time to complete the FL training task. A FL client task queue may store multiple FL tasks for a FL client. For example, separate tasks can be queued for different ML algorithms/models which the FL service would like a FL client to perform training operations on. The FL service may order the FL tasks in the queue based on priority (e.g., leveraging priority information defined by the FL user within the FL job, or leveraging internal FL service policies). A client may process more than one FL task in parallel if the FL client has sufficient resources to do so.

TABLE 2
FL Task Information

| Informational | |
|---|---|
| Element | Description |
| FL client ID | Identifier of the FL client that will perform |
| | this task |
| FL task ID | Identifier of the FL task sent to a FL client. |
| | This may be used coordinate the exchange of |
| | FL task specific information between a FL |
| | client and FL service. |
| FL job ID | Identifier of the FL job associated with the |
| | FL task. |
| FL task priority | Priority of the FL task. A priority may be |
| | determined by the FL service or may be |
| | assigned by a FL user (e.g., based on a FL |
| | job priority). This priority may be used by |
| | the FL client and/or FL service to prioritize |
| | the processing of the FL task. For example, |
| | if a FL client is configured with multiple |
| | FL tasks to perform, this priority may be |
| | used to determine an order in which to |
| | perform the FL tasks. |
| FL round number | An identifier indicating the FL round this |
| | FL task is associated with. In FL, there |
| | are generally multiple rounds of training |
| | performed until the training of the model |
| | meets the completion criteria (e.g., a |
| | required level of accuracy is achieved). |
| | Each round begins with a new version of |
| | the global model being distributed from |
| | the FL service to the FL clients and ends |
| | with the FL clients updating the FL |
| | service with the new model parameters |
| | computed by the FL client which the FL |
| | service aggregates and uses to generate a |
| | new global model. |
| FL task starting | Conditions defining when the FL client |
| conditions | should start processing the FL task. Examples |
| | of conditions may include an indication to |
| | start immediately (upon creation of the FL |
| | task), start at a specified relative time |
| | (in 1 hour) or absolute time (March 10 |
| | at 2pm), start upon detection of a specified |
| | event condition such as when one or more |
| | FL clients are available or have necessary |
| | resources (e.g., CPU, memory, battery) |
| | available. This parameter may consist of |
| | more than one condition. A FL service may |
| | configure this parameter such that it is |
| | derived by and/or |
| | aligned with the FL job starting conditions. |
| FL task stopping | Conditions defining when the FL client |
| conditions | should stop the processing the FL task. |
| | Examples of conditions may include an |
| | achieved ML model accuracy or performance, |
| | a training time limit, a percentage of |
| | training completed, an amount of training |
| | data samples processed. A FL service may |
| | configure this parameter such that it is |
| | derived by and/or aligned with the FL job |
| | stopping conditions. |
| FL task control | Once a FL task is created, a FL service may |
| | update this information element to manually |
| | to trigger the FL client to start, pause, |
| | re-start, or stop/cancel the processing of |
| | the FL task. |
| FL task status | FL task status information which the FL |
| | client makes available during the |
| | processing of the FL task. Examples |
| | of FL task status information may include |
| | a status indicating whether the FL task |
| | is pending and not started yet, started, |
| | paused, resumed, stopped/cancelled, |
| | completed. Some additional examples of |
| | FL task status can be the current training |
| | round or some additional information |
| | regarding why training has been paused or |
| | stopped (e.g., low battery or high CPU |
| | utilization). Alternatively, this |
| | information element may comprise a FL |
| | service contact address (e.g., URI/URL) |
| | where the FL client should send FL task |
| | updates to the FL service. In addition to |
| | a contact address, instructions and or |
| | conditions for providing status updates |
| | may also be provided. For example, the |
| | FL service may request to be updated if |
| | the duration of time the FL client takes |
| | to perform training within a training |
| | round exceeds a specified value. |
| FL task functions | Functions (e.g., scripts) which the FL |
| | service is requesting that the FL client |
| | perform as part of the FL task. These |
| | functions or scripts may be passed to the |
| | FL client as part of the FL task creation. |
| | Alternatively, a location (e.g., URI/URL) |
| | of where the FL client can access and/or |
| | download functions or scripts (e.g., from |
| | the FL service or another service in the |
| | system) may be provided. |
| ML algorithms/models | ML algorithms/models and versions that |
| | should be used. Actual ML algorithms/models, |
| | links (e.g., URIs/URLs) where ML |
| | algorithms/models can be accessed and/or |
| | downloaded, or identifiers of ML |
| | algorithms/models may be provided. For |
| | example, identifiers for a specific |
| | library implementation or a generic |
| | algorithm description, such as decision |
| | tree or neural network may be provided. |
| | Configurations for the ML algorithms/models |
| | may also be provided, such as number of |
| | hidden layers, learning rate, maximum depth |
| | of decision trees, regularization type, |
| | regularization constant, etc. Any needed |
| | credentials to access ML algorithms/models |
| | may also be included. |
| input model | Any initial values of ML model parameters |
| parameters | required by the FL client to perform the |
| | FL training task. Actual model parameters |
| | values may be provided or links (e.g., |
| | URIs/URLs) where model parameters can be |
| | accessed and/or downloaded may be provided. |
| | Any needed credentials to access the ML |
| | model parameters may also be provided. |
| output model | During and after the processing of a FL |
| parameters | task, the FL client may make output model |
| | parameters available to the FL service. |
| | The output model parameters may be |
| | updated and stored within the FL task |
| | information stored on the FL client. |
| | Alternatively, the FL client may send |
| | output model parameters to a FL service |
| | location (e.g., URI/URL) configured within |
| | this information element. |
| data filter | Data filters that the FL client should |
| | use when performing the FL training task. |
| | For example, a data set time window or a |
| | subset of features in the FL client's |
| | data set. |
| Training | Contains parameters for the FL client to |
| configuration | manage the machine learning process, such |
| | as the number of data instances required |
| | for the training round, time to complete |
| | the round, the sequence of ML models to |
| | train (if multiple models are specified), |
| | etc. In addition to specifying a time to |
| | complete the round, one or more actions |
| | that the FL client is to perform if |
| | processing of the FL task is not complete |
| | by the specified time limit may also be |
| | specified. For example, FL client is to |
| | provide whatever updates to model parameters |
| | it has at expiration of this specified time |
| | limit even if the task has not completed, |
| | or the FL client is to abort and cancel |
| | processing of the FL task and not report |
| | model parameters to the FL service |

Before the FL service creates FL tasks on a FL client, the FL client and FL Service may establish a connection to one another. This connection may be initiated by the FL client or FL service. In addition to exchanging connection related information such as a unique network address and authentication credentials, FL client capabilities such as but not limited to the capabilities defined in Table 3 may also be provided by a FL client to the FL service upon connection establishment. For example, an FL client ID, environment and resources, supported ML algorithms, and data set information may be provided by the FL client.

TABLE 3
FL Client Capabilities

| Informational | |
|---|---|
| Element | Description |
| FL client ID | Identifier of the FL client |
| environment and | Information regarding the capabilities of the FL |
| resources | client, such as the operating environment, FL |
| | framework, runtime requirements, available processor |
| | and memory capabilities to perform FL tasks. |
| supported ML | Types of ML algorithms/models and the associated |
| algorithms | versions that can be supported by the FL client. |
| data set | Information regarding the available data sets of |
| information | the FL client. For example, identifiers, structures |
| | and/or types of data sets and/or data set features. |
| | In addition, information regarding the number of |
| | data samples per dataset, age of each dataset, |
| | indicator that data has been prepared for ML |
| | training (e.g., labeled) may also be provided. |

At step 3, upon receiving the request, the FL client may check that the FL service is authorized to access the FL client and create the FL task. To perform this check the FL client may check whether the FL service has FL task creation privileges defined within an access control policy of the FL client. In addition, the FL client may also check one or more individual information elements configured in the FL task information included within the request to determine whether the FL service has necessary privileges. For example, whether the FL service has privileges to configure the FL client with the specified ML algorithms/models and/or FL task functions. If authorization is successful, the FL client may create the FL task by storing the specified FL task information such that it can be accessed by the FL client. The FL task information may be stored locally at the FL client or may be stored in another service (e.g., storage service) which the FL client interconnects with. In addition, the FL client may determine if it needs to perform any FL task centric operations such as start the processing of the FL task. This determination may be made using the specified FL task start conditions.

At step 4, the FL client may send a response back to the FL service. The response may comprise one or more information elements defined in Table 2. For example, a FL task ID. The response may also comprise additional information such as a status code indicating whether or not the FL task was created or not.

At step 5, once a FL task is created, a FL service may send a subsequent request to the FL client to update the FL task. The update request may comprise one or more information elements such as but not limited to those defined in Table 2. For example, in the event that the FL service does not define FL task start conditions when creating the FL task, the FL service may send a FL task update request to manually trigger the FL client to start the FL task (e.g., via configuring the FL task control information element).

At step 6, upon receiving FL update request, the FL client may check that the FL job ID and/or FL task ID within the request references a valid FL job and/or FL task and that the FL service is authorized to access the FL client and update this FL task. To perform this check, the FL client may use similar checks as defined in Step 3. If authorization is successful, the FL client may update the FL task by updating the FL task information with the one or more information elements specified in the request. In addition, the FL client may determine if it needs to perform any FL task centric operations such as start, pause, re-start or stop the processing of the FL task.

At step 7, the FL client may send a response back to the FL service. The response may comprise one or more information elements defined in Table 2. For example, the response may comprise information elements which were successfully updated along with their values. The response may also comprise additional information such as a status code indicating whether or not the FL task was updated or not.

At step 8, the FL client performs the FL task specified by the FL service. When performing the FL task, the FL client may check the priority defined within the FL task information to determine an order it should perform the FL task with respect to other FL tasks it needs to perform. The FL client may also process and perform one or more FL functions (e.g., scripts) defined within the FL task information by the FL service. This may require that the FL client access and/or download functions/scripts from locations (URIs/URLs) configured in the FL task information. The FL client may also download and/or select one or more ML algorithms/models based on information configured in the FL task information (e.g., ML algorithms/models types, identifiers, and/or locations (e.g., URIs/URLs). The FL client may apply initial model parameters configured in the FL task information to the ML algorithms/models. The FL client may apply data filter(s) to the training data that it uses to train the ML algorithms/models. The FL client may determine when to stop training using the FL task stopping conditions and/or FL task control information configured in the FL task information. The FL client may also update FL task status information within the FL task information during the processing of the FL task.

At step 9, a FL service may send a FL task retrieve request to a FL client to retrieve FL task information. For example, the FL service may retrieve FL status information from the FL client to determine FL training results and/or progress information.

At step 10, upon receiving the FL task retrieve request, the FL client may respond with the request FL task information. For example, the FL client may respond with an entire FL task information or a subset of information elements within the FL task information such FL client ID, FL task ID, FL job ID, FL round number, and FL task status.

At step 11, instead or in addition to retrieving FL task information from a FL client, a FL service may send subscription request(s) to the FL service to subscribe to a FL task and receive notifications from the FL client if/when notification criteria associated with the FL task have been met. The subscription request may include notification criteria. The notification criteria may comprise one or more conditions. The conditions may reference information elements defined within the FL task information. For example, notification criteria may comprise a condition for when the FL task status equals completed.

At step 12, upon receiving the FL task subscription request, the FL client may create the FL task subscription by storing the subscription information such that it can be accessed by the FL client. The FL task subscription may be stored locally at the FL client or may be stored in another service (e.g., storage service) which the FL client interconnects with. In addition, the FL client may start monitoring the specified notification criteria to determine if/when the criteria have been met.

At step 13, the FL client may send a response back to the FL service. The response may comprise a FL task subscription ID. The response may also comprise additional information such as a status code indicating whether or not the FL task subscription was successfully created or not.

At step 14, if/when the FL client detects that the notification criteria defined within a FL task subscription has been met, the FL client may generate a FL task notification which it sends to the FL service. The notification may comprise a FL service ID, FL client ID, FL job ID, FL task ID, FL round number, FL task status and/or a FL task subscription ID. The notification may also comprise additional information such as FL task defined in Table 2.

At step 15, the FL service may send a response back to the FL client indicating that the notification was received. The response may comprise a FL service ID and/or FL task subscription ID. The response may also comprise additional information such as a status code indicating whether or not the FL task notification was successfully received and processed.

Notes, steps 2 thru 15 may be repeated for each FL training round (for FL clients that are selected) until the FL task stopping conditions are met. In the subsequent FL training rounds, if the FL task configuration for a FL client remains unchanged, the FL service may send a FL task update request to the FL client without creating a new FL task (skipping steps 2 thru 4). Depending on whether the FL service prefers to retrieve FL status and results from FL clients, the FL service may opt to perform steps 9 and 10, or steps 11 thru 15. Not shown in the figure, but FL clients may instead initiate messages to the FL service to share FL status and results. For example, the FL service may provide contact information to the FL clients (e.g., within FL task information), which the FL client use to target requests towards.

During the processing of a FL job, the FL service may perform some additional FL job management operations not described in Steps 1 thru 15. For example, before combining the model parameters which the FL service receives from the FL clients in each FL training round, the FL service may perform some analytics on the parameters to evaluate the quality of the updated parameters. Model parameters from the FL client may then be selected based on the analytic evaluation and then be aggregated using a dynamic or custom defined algorithm that results in a single global model. The FL service may also maintain a model repository where the FL Clients may send updated model parameters to. The model repository may also be used by the FL service to store the initial global model used in the FL process, intermediate models from the FL Clients, and/or the aggregated global models from each round of FL training. The model repository may require proper authentication for the FL clients to access it such that FL clients may only access the global models and not the intermediate model updates generated by other FL clients. The FL service may also allow a FL user to specify policies and criteria to accept and analyze the model parameters returned from FL clients. For example, policies and scripts specified by the FL user can be used by the FL service to process model parameters provided by the FL clients. The model repository may comprise information such as but not limited to the information captured in Table 4.

TABLE 4
Model Parameter Repository

| Informational | |
|---|---|
| Element | Description |
| model | Identifier of the model parameters |
| parameter ID | |
| FL client ID | Identifier of the FL client that generated these model |
| | parameters |
| FL task ID | Identifier of the FL task associated with these model |
| | parameters |
| FL job ID | Identifier of the Job associated with these model |
| | parameters |
| Round | The model parameters computed by the individual FL |
| Number | clients may be stored by the FL service on a per round |
| | basis. If this is the case, the FL service may store an |
| | associated round number with each set of model |
| | parameters for a given round. This round number can |
| | be used to correlate, aggregate or discover model |
| | parameters that may be aggregated. |
| ML model | Location of the model parameters. This may include |
| parameter | protocol, credentials and other information necessary to |
| location | read or write model parameters to this location. |
| analytics | Results of any analytics that were run on these model |
| report | parameters. |
| analytics | Results of the analytics report may determine that the |
| actions | client should not transfer the model parameters (to save |
| | bandwidth and storage space). Alternatively, the results |
| | may indicate that these parameters should be aggregated |
| | into the next model. |
| evaluation | Results of any evaluations that were performed on these |
| result | model parameters |
| source | List of Model ID or location that was the baseline model |
| model list | for training that resulted in this model. This may be a |
| | single model in the case that it was the basis for training. |
| | Alternatively, it may be a list of models that were |
| | aggregated to this single model. This establishes a |
| | lineage for the new model parameters. |
| resulting | List of Model ID or locations that were created from this |
| models list | model. For example, this may list all of the updated |
| | model parameters provided from FL clients during this |
| | particular round of FL training. |
| aggregation | Algorithm that is used to combine the model parameters |
| algorithm | from FL clients. This may be a script that is executed to |
| | perform the aggregation, or it can be an identifier of an |
| | aggregation strategy that the FL service supports. |

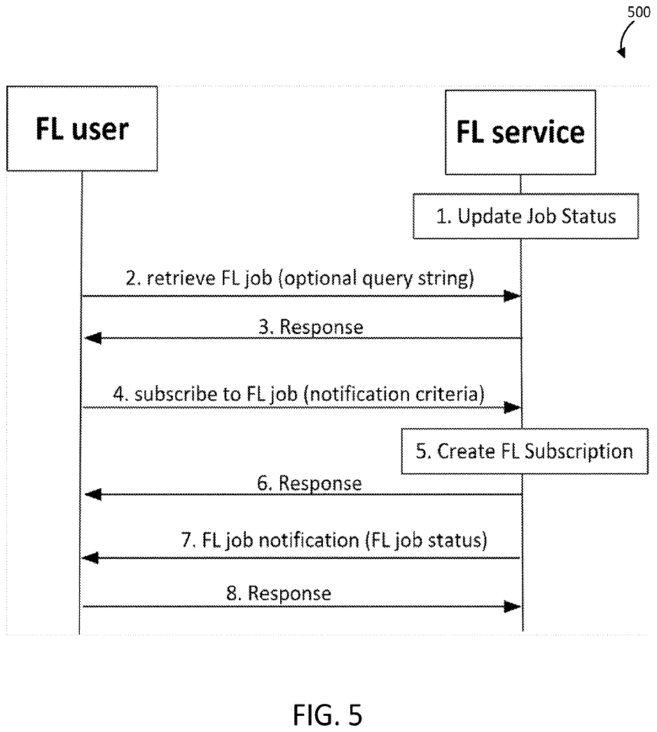

FIG. 5 shows an example FL job status procedure 500. As shown in FIG. 5, a FL service may provide a FL user with status information regarding a FL job. The FL service may provide FL job status during the active processing and execution of a FL job or at the successful or unsuccessful completion of a FL job. The status of a FL job may be shared with a FL user, via the FL user retrieving the status from the FL service. Alternatively, a FL user may subscribe to receive FL job notifications from the FL service if/when FL job related events of interest to the FL user occur.

When the client begins the FL task it may provide status updates for each FL task it performs. The FL Service may optionally consolidate and/or forward the FL task status updates to the FL user. The updates of the FL task may be monitored by the FL service for each FL task and FL job so that the FL user may monitor progress of the FL job. As the FL clients execute the FL tasks that support a FL job, the user is able to monitor the status of the FL job or the supporting FL tasks. Leveraging this information the FL user can become informed and may use this information to determine whether to modify pending FL jobs and tasks for specific FL clients, remove FL clients from a FL job, add new FL clients to a FL job, exclude results, i.e. model parameters, from a FL client while the FL client continues to participate in the FL process.

At step 1, the FL service updates the status of a FL job. The status may include a change in the state of the FL job such as the FL job has been started, paused, resumed, stopped, or completed. The status may include FL job results such as an indication whether the FL job completed successfully, an error occurred, an achieved level of model accuracy or performance was achieved, a training round or task completed, or a trained model and/or model parameters is ready for the FL user. The status may include a change in status with respect to one or more FL clients associated with a FL job or one or more FL tasks associated with these FL clients and the FL job. For example, a change in the state of a FL task associated with a FL client such as the FL task has been started, paused, resumed, stopped, or completed. The status may include FL task results such as an indication whether the FL task completed successfully, or an error occurred. The status may indicate the configuration, resources, or the availability of a FL client has changed.

At step 2, a FL user may send a FL job retrieve request to a FL service to retrieve FL job information. For example, the FL user may retrieve FL job status and results information from the FL service to determine FL training results and/or progress information.

At step 3, upon receiving the FL job retrieve request, the FL service may respond with the requested FL job information. For example, the FL service may respond with an entire FL job or a subset of information elements within the FL job such FL job ID, FL job status and/or FL job results.

At step 4, instead of retrieving FL job information from a FL service, a FL user may send subscription request(s) to the FL service to subscribe to a FL job and receive notifications from the FL service if/when notification criteria associated with the FL job have been met. The subscription request may include notification criteria. The notification criteria may comprise one or more conditions. The conditions may reference information elements defined within the FL job. For example, notification criteria may comprise a condition for when the FL job status changes value.

At step 5, upon receiving the FL job subscription request, the FL service may create the FL job subscription by storing the subscription information such that it can be accessed by the FL service. The FL job subscription may be stored locally at the FL service or may be stored in another service (e.g., storage service) which the FL service interconnects with. In addition, the FL service may start monitoring the specified notification criteria to determine if/when the criteria have been met.

At step 6, the FL service may send a response back to the FL user. The response may comprise a FL job subscription ID. The response may also comprise additional information such as a status code indicating whether or not the FL job subscription was successfully created or not.

At step 7, if/when the FL service detects that the notification criteria defined within a FL job subscription has been met, the FL service may generate a FL job notification which it sends to the FL user. The notification may comprise a FL service ID, FL job ID, FL round number, FL job status and/or a FL job subscription ID. The notification may also comprise additional information such FL job information such as but not limited to the information defined in Table 1.

At step 8, the FL service may send a response back to the FL client indicating that the notification was received. The response may comprise a FL service ID and/or FL task subscription ID. The response may also comprise additional information such as a status code indicating whether or not the FL task notification was successfully received and processed.

Note, steps 1 thru 8 may occur at different times during the lifecycle of a FL job. For example, a FL service may receive these requests while the FL service is actively processing a FL job. Alternatively, these steps may occur when the FL service completes processing a FL job. Depending on whether the FL user prefers to retrieve FL status and results from a FL service, the FL user may opt to perform steps 2 and 3, or steps 4 thru 8.

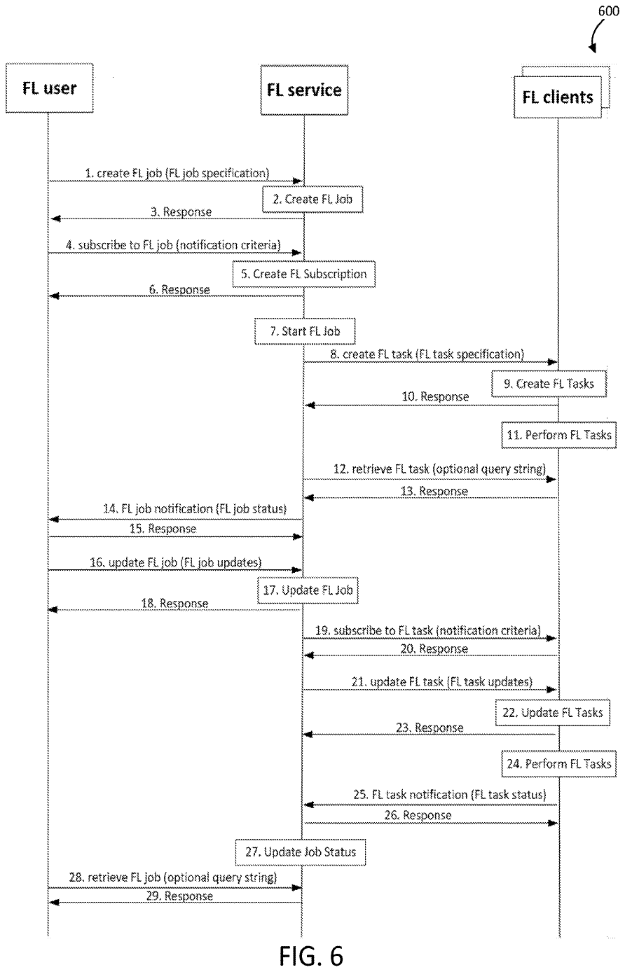

FIG. 6 shows an example end-to-end embodiment 600 involving a FL user, FL service, and FL clients. In this embodiment, the operations defined in the aforementioned procedures are shown together in an example. Note that the embodiment is one example of how the aforementioned procedures may interact with each other. Other embodiments may be envisioned as well.

Steps 1-3 correspond to steps 1-3 of FIG. 3. A FL user may have a ML training application that may benefit from FL training and may make a request to a FL service to manage the federated training. The FL user may provide the information as shown in Table 1 for the FL job. If successful, the FL service may create the FL job and assign a FL ID for the job.

Steps 4-6 correspond to steps 4-6 of FIG. 5. A FL user may want to receive notifications from the FL service about the progress of the FL job. Hence the FL user may send a subscription request to the FL service with the FL job ID. The subscription request may specify notification criteria for when to notify the FL user.

In step 7, the FL job may be started automatically if the FL job starting conditions IE was configured or it may be started by an explicit request from the FL user. In this example, the FL job was started based on a condition specified by the FL job starting conditions IE.

Steps 8-10 correspond to steps 2-4 of FIG. 4. The FL service may create FL specific tasks on each FL client participating in the FL training. The tasks may be configured to coordinate and manage the training of the ML algorithm(s)/model(s) in a federated manner. The FL task information may be specified as shown in Table 2.

Steps 11-13 correspond to steps 8-10 of FIG. 4. Each FL client may perform the FL task specified by the task information configured by the FL service. The FL service may retrieve the FL status information from the FL clients to check on the progress of the training task.

Steps 14-15 correspond to steps 7-8 of FIG. 5. The FL service may send the FL user a notification to provide an update of the task progress. The subscription criteria may have requested the FL service to notify the FL user of task status updates.

Steps 16-18 correspond to steps 4-6 of FIG. 3. For example, in response to a FL job notification, the FL user may want to update the FL job information to modify the starting or stopping conditions of the FL job, modify the priority of the FL job with respect to other FL jobs, switch the ML algorithms associated with the FL job, modify hyperparameters of the FL job, modify the aggregation algorithm, modify the minimum number of training rounds, modify the minimum number of FL clients, modify the minimum number of total data instances, or change the configuration of the FL clients.

Steps 19-20 correspond to steps 11-13 of FIG. 4. The FL service makes a subscription to the FL clients to be notified of certain notification criteria. For example, the FL service may subscribe to FL client(s) to detect if/when updates to a FL client's task status occurs such as when the FL client starts, pauses, resumes, cancels or completes a FL task.

Steps 21-23 correspond to steps 5-7 of FIG. 4. For example, in response to receiving an update of the FL job information from a FL user as shown in steps 16-18, the FL service may make corresponding task updates to the FL clients. For example, if the FL user modifies the minimum number of data instances and/or the FL client configuration, the FL service may update the FL client accordingly.

In step 24, each FL client may perform the task specified by the task update received from the FL service.

Steps 25-26 correspond to steps 14-15 of FIG. 4. At some later instance in time, an event triggers and one or more FL clients may send notifications to the FL service if the event matches the notification criteria event specified in the subscription.

In step 27, the FL service may update the status of the job based on receiving the notifications from the FL clients.

Steps 28-29 correspond to steps 2-3 of FIG. 5. At any time during the operations of the FL job, the FL user may make a retrieve request to get an update on the status of the FL job. The FL user may want to check on the status of the job or to retrieve information about the FL job.

One of the approaches to realize the aforementioned FL service data preparation functionality is through a RESTful API supported by the FL service. The RESTful API may comprise one or more different types of resources hosted and stored by the FL service which are accessed by FL clients and FL users via RESTful operations commonly referred to as methods (e.g., PUT, POST, GET, DELETE). Each type of resource defined for the API may comprise a defined set of information elements commonly referred to as attributes. These resource types and their respective attributes provide a means for the FL service to receive information from FL clients and FL users using RESTful protocols such as HTTP, process the information by performing FL service specific tasks, and provide results of these operations back to the FL clients and FL users. Hence the RESTful APIs are used by FL clients and FL users to interface with the FL service and access the supported capabilities of the FL service in a RESTful manner.

The RESTful API of the FL service may support a FL job resource type. This FL job resource may comprise attributes such as but not limited to those defined in Table 1. Other high level FL configurations such as minimum number of training rounds, minimum number of FL clients (for each training round and for the entire FL process), and minimum number of total data instances may also be provided by the FL user.

The FL service may also support FL task resource type. This FL task resource may comprise attributes such as but not limited to the information elements defined in Table 2.

The FL service may also support a FL client resource type. This FL client resource may comprise attributes such as but not limited to those defined in Table 3.

The FL service may also support a ML model parameter repository resource type. This ML model parameter repository resource may comprise attributes such as but not limited to the information elements defined in Table 4.

The FL service may also support additional resource types. For example, the FL service may support a resource type which is used by FL clients to queue up and receive FL tasks from the FL service. This resource may be separate from the aforementioned FL client or FL task resource types.

The aforementioned FL job, FL task, FL client and FL model parameters related information elements defined in Table 1, Table 2, Table 3, and/or Table 4, respectively, may be incorporated into a GUI. One or more of these information elements may be incorporated.

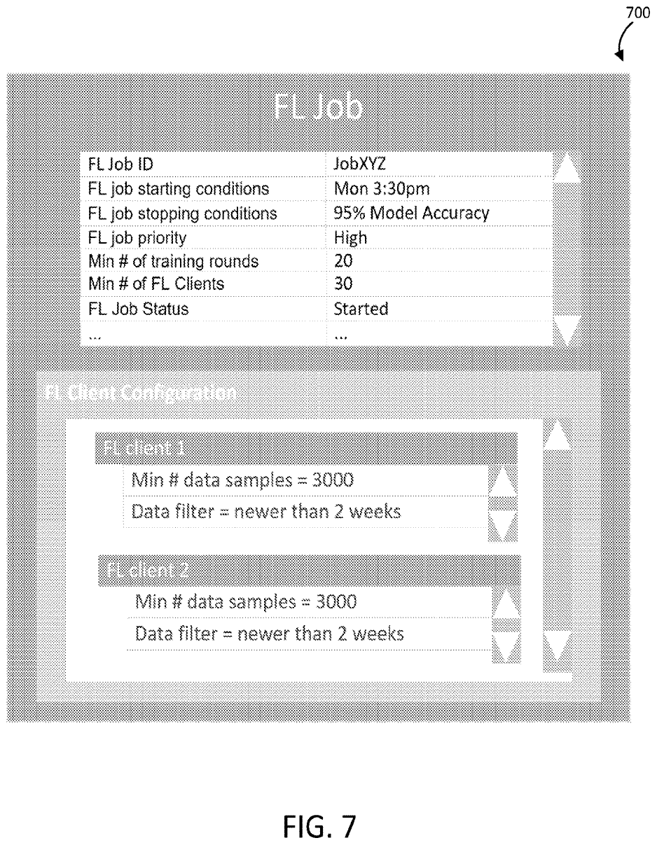

FIG. 7 shows an example FL job GUI embodiment 700. A FL user may interact with the FL service via this GUI to perform the aforementioned operations defined in this invention. For example, a FL user may configure the FL service with a FL job via this GUI and monitor and track the status of the FL job as it is executed by the FL service.

### Example Communications System

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHZ, and the provision of new ultra-mobile broadband radio access above 7 GHz. The flexible radio access is expected to consist of a new, non-backwards compatible radio access in new spectrum below 7 GHZ, and it is expected to include different operating modes that may be multiplexed together in the same spectrum to address a broad set of 3GPP NR use cases with diverging requirements. The ultra-mobile broadband is expected to include cmWave and mmWave spectrum that may provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

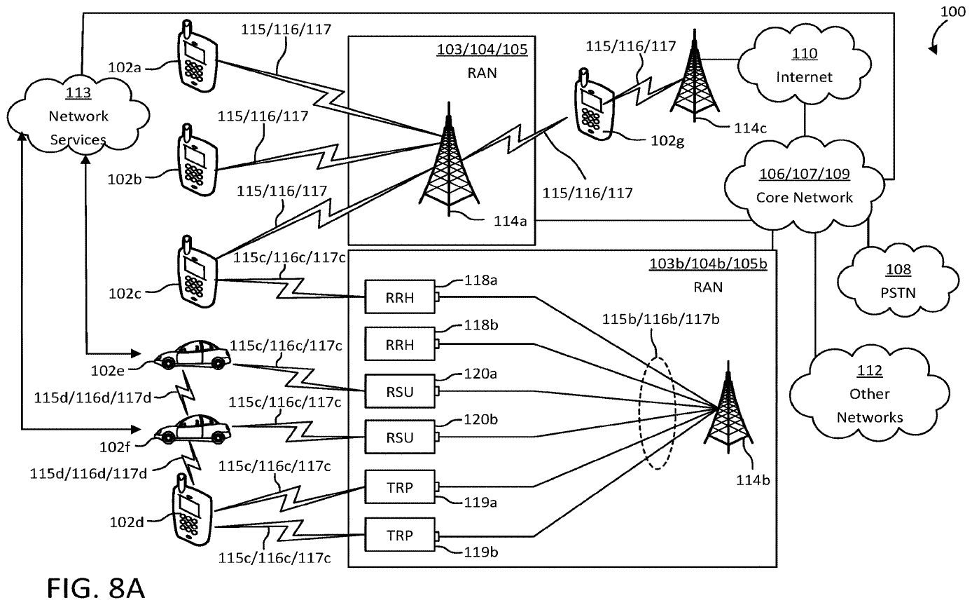

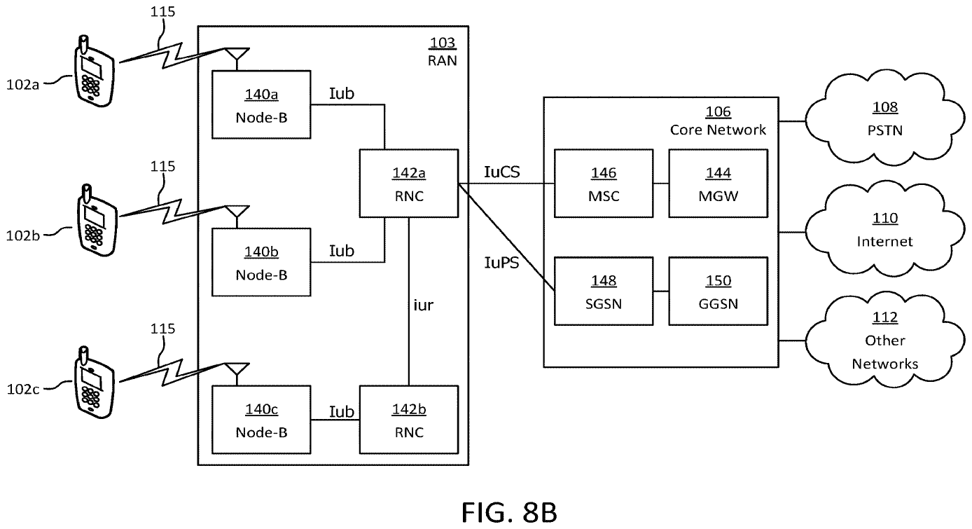

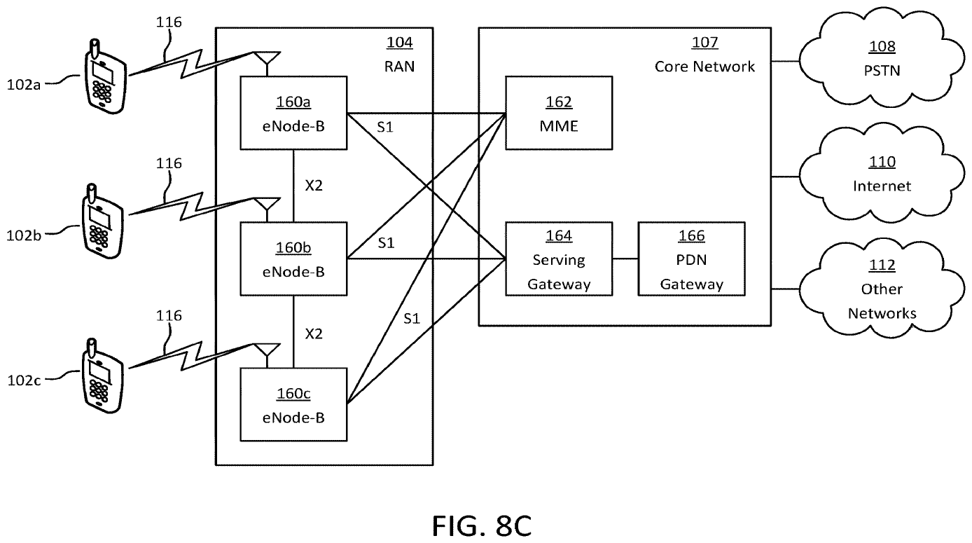

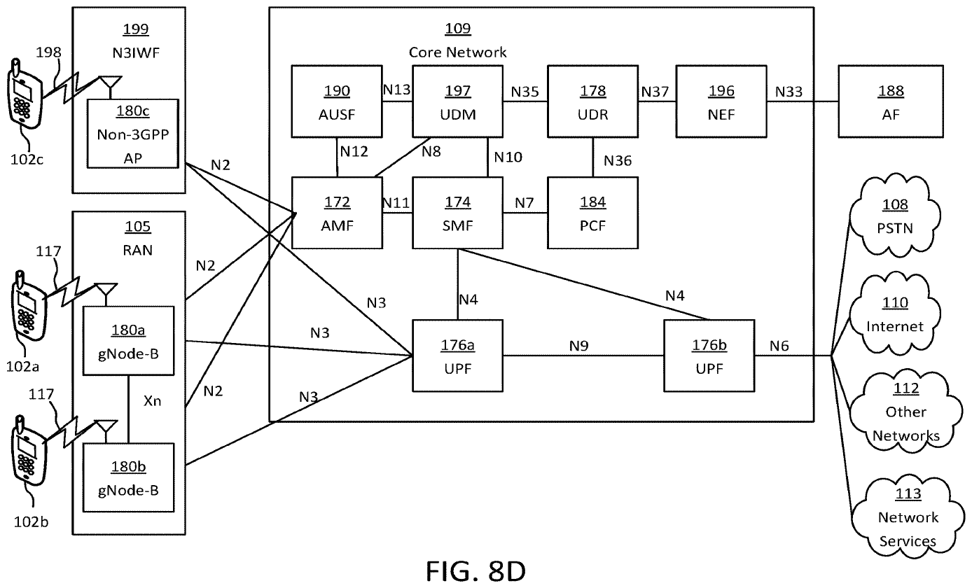

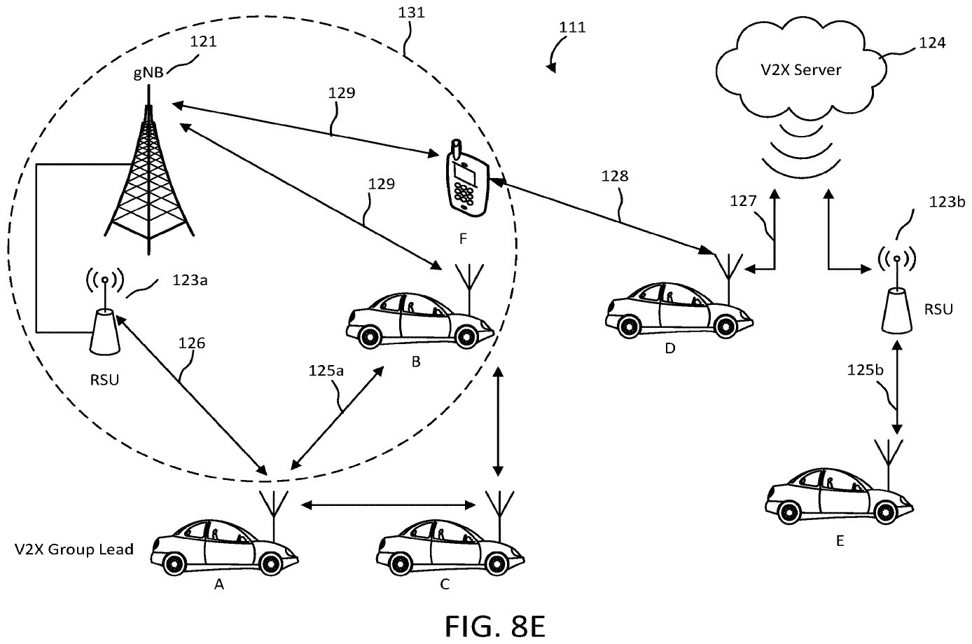

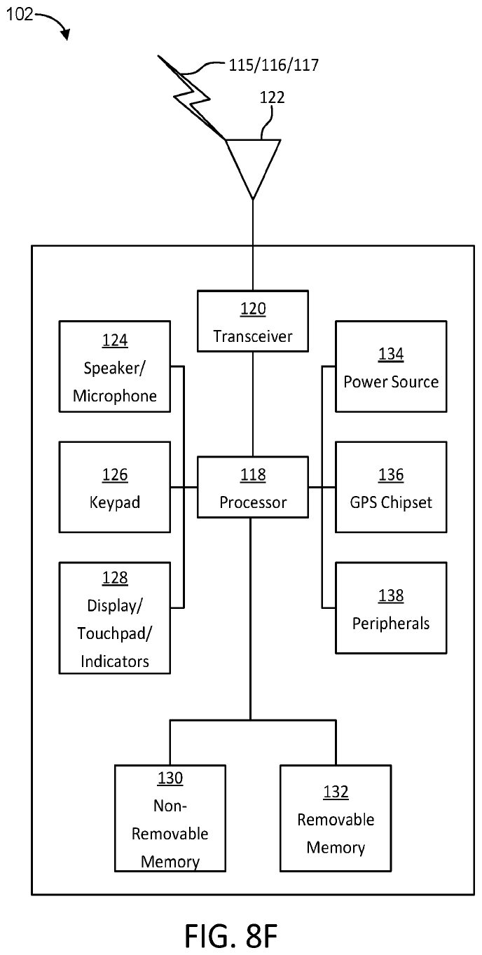

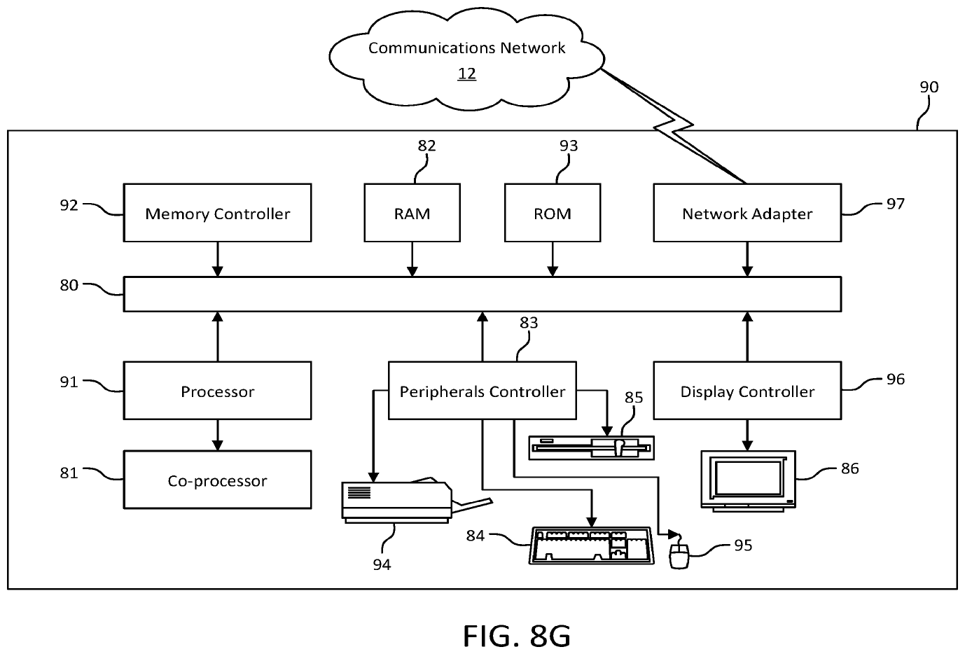

FIG. 8A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It may be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 8A, each of the WTRUs 102 is depicted in FIGS. 8A-8E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 8A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 8A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 8A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VOIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 8A, it may be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 8A may be configured to communicate with the base station 114a, which may employ a cellular-based radio technology, and with the base station 114c, which may employ an IEEE 802 radio technology.

Although not shown in FIG. 8A, it may be appreciated that a User Equipment may make a wired connection to a gateway. The gateway maybe a Residential Gateway (RG). The RG may provide connectivity to a Core Network 106/107/109. It may be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 8B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 8B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It may be appreciated that the RAN 103 may include any number of Node-Bs and Radio Network Controllers (RNCs.)

As shown in FIG. 8B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 8B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it may be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 8C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it may be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 8C, the eNode-Bs 160a, 160b, and 160c may communicate with one another over an X2 interface.

The core network 107 shown in FIG. 8C may include a Mobility Management Gateway (MME) 162, a serving gateway 164, and a Packet Data Network (PDN) gateway 166. While each of the foregoing elements are depicted as part of the core network 107, it may be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 8D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It may be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It may also be appreciated the RAN 105 may employ more than one type of base station. For example, the RAN may employ eNode-Bs and gNode-Bs.

The N3IWF 199 may include a non-3GPP Access Point 180c. It may be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 8D, the gNode-Bs 180a and 180b may communicate with one another over an Xn interface, for example.

The core network 109 shown in FIG. 8D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 8G.

In the example of FIG. 8D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it may be appreciated that any one of these elements may be owned and/or operated by an entity other than the core network operator. It may also be appreciated that a 5G core network may not consist of all of these elements, may consist of additional elements, and may consist of multiple instances of each of these elements. FIG. 8D shows that network functions directly connect to one another, however, it should be appreciated that they may communicate via routing agents such as a diameter routing agent or message buses.

In the example of FIG. 8D, connectivity between network functions is achieved via a set of interfaces, or reference points. It may be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 8D.

The SMF 174 may be connected to the AMF 172 via an N11 interface. Similarly, the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 8D. The PCF 184 may provide policy rules to control plane nodes such as the AMF 172 and SMF 174, allowing the control plane nodes to enforce these rules. The PCF 184 may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function may add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface, and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that may be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators may use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 8D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 8A, 8C, 8D, and 8E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 8A, 8B, 8C, 8D, and 8E are provided by way of example only, and it is understood that the subject matter disclosed and claimed herein may be embodied or implemented in any similar communication system, whether presently defined or defined in the future.

FIG. 8E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 8E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 8E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 8F is a block diagram of an example apparatus or device WTRU 102 that may be configured for wireless communications and operations in accordance with the systems, methods, and apparatuses described herein, such as a WTRU 102 of FIG. 8A, 8B, 8C, 8D, or 8E. As shown in FIG. 8F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It may be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 8F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 8F depicts the processor 118 and the transceiver 120 as separate components, it may be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 8A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It may be appreciated that the transmit/receive element 122 may be configured to transmit and/or receive any combination of wireless or wired signals.

In addition, although the transmit/receive element 122 is depicted in FIG. 8F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It may be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 8G is a block diagram of an exemplary computing system 90 in which one or more apparatuses of the communications networks illustrated in FIGS. 8A, 8C, 8D and 8E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that may not easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 8A, 8B, 8C, 8D, and 8E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

What is claimed is:

1-20. (canceled)

21. An apparatus associated with a federated learning (FL) service, the apparatus comprising one or more processors and memory storing instructions which, when executed by the one or more processors, cause the apparatus to:
receive, from an FL user, a request to create or update an FL job, wherein the request to create or update the FL job comprises:
an indication of a machine learning (ML) model to be distributed to FL clients or an indication of one or more ML requirements, and
a list of FL clients or an indication of one or more FL training requirements;
determine whether the FL user is authorized to perform the FL job;
select one or more FL clients based on the list of FL clients or the one or more FL training requirements;
send, to the FL user, a response comprising a FL job ID and FL request status information;
send, to the one or more FL clients, one or more FL task requests comprising FL task information;
receive, from the one or more FL clients, FL task status information; and
send, to the FL user, FL job status information based on the FL task status information.

22. The apparatus of claim 21, wherein the request to create or update the FL job comprises the indication of the one or more ML requirements, and wherein the instructions, when executed by the one or more processors, further cause the apparatus to:
determine whether to perform one or more FL training rounds based on comparing the FL task status information to the one or more ML requirements.

23. The apparatus of claim 22, wherein the one or more ML requirements indicate at least one of: one or more ML algorithms, an ML problem type, a multi-model training mode, one or more hyperparameters, a model evaluation function, model initialization, an aggregation algorithm, a minimum number of FL training rounds, a minimum number of FL clients, or a minimum number of total data instances.

24. The apparatus of claim 21, wherein the request to create or update the FL job comprises the indication of the one or more FL training requirements, and wherein the instructions, when executed by the one or more processors, cause the apparatus to select the one or more FL clients based on the one or more FL clients meeting the one or more training requirements.

25. The apparatus of claim 21, wherein the request to create or update the FL job further comprises an indication of a type of data for the one or more FL clients to use for the FL job.

26. The apparatus of claim 21, wherein the FL job status information indicates at least one of: a status indicating whether the FL job has been started, paused, resumed, stopped, canceled, or completed.

27. The apparatus of claim 21, wherein the request to create or update the FL job further comprises an indication of a stopping condition for the one or more FL clients to apply when performing one or more FL tasks indicated by the one or more FL task requests.

28. The apparatus of claim 21, wherein the FL task status information comprises an indication of whether one or more FL tasks indicated by the one or more FL task requests were successfully completed.

29. An apparatus associated with a federated learning (FL) client, the apparatus comprising one or more processors and memory storing instructions which, when executed by the one or more processors, cause the apparatus to:
receive, from an FL service, one or more FL task requests comprising FL task information, wherein the FL task information indicates a machine learning (ML) model to be used to perform one or more FL tasks at the apparatus;
perform, based on the one or more FL task requests, the one or more FL tasks; and
send, to the FL service, one or more notifications comprising FL task status information based on the performance of the one or more FL tasks.

30. The apparatus of claim 29, wherein the one or more FL task requests further comprise an indication of a type of data for the FL client to use for the one or more FL tasks.

31. The apparatus of claim 30, wherein the indication of the type of data for the FL client to use comprises an indication of at least one of: feature values for training data associated with the one or more FL tasks, a time window for training data associated with the one or more FL tasks, a minimum number of sample data for training data associated with the one or more FL tasks, or a maximum age for training data for training data associated with the one or more FL tasks.

32. The apparatus of claim 29, wherein the FL task status information indicates at least one of: a status indicating whether one or more FL tasks have been started, paused, resumed, stopped, canceled, or completed.

33. A method comprising:
receiving, from an FL user, a request to create or update an FL job, wherein the request to create or update the FL job comprises:
an indication of a machine learning (ML) model to be distributed to FL clients or an indication of one or more ML requirements, and
a list of FL clients or an indication of one or more FL training requirements;
determining whether the FL user is authorized to perform the FL job;
selecting one or more FL clients based on the list of FL clients or the one or more FL training requirements;
sending, to the FL user, a response comprising a FL job ID and FL request status information;
sending, to the one or more FL clients, one or more FL task requests comprising FL task information;
receiving, from the one or more FL clients, FL task status information; and
sending, to the FL user, FL job status information based on the FL task status information.

34. The method of claim 33, wherein the request to create or update the FL job comprises the indication of the one or more ML requirements, and wherein the method further comprises:
determining whether to perform one or more FL training rounds based on comparing the FL task status information to the one or more ML requirements.

35. The method of claim 34, wherein the request to create or update the FL job comprises the indication of the one or more ML requirements, and wherein the one or more ML requirements indicate at least one of: one or more ML algorithms, an ML problem type, a multi-model training mode, one or more hyperparameters, a model evaluation function, model initialization, an aggregation algorithm, a minimum number of FL training rounds, a minimum number of FL clients, or a minimum number of total data instances.

36. The method of claim 33, wherein the request comprises the indication of the one or more FL training requirements, and wherein the method further comprises selecting the one or more FL clients based on the one or more FL clients meeting the one or more training requirements.

37. The method of claim 33, wherein the request to create or update the FL job further comprises an indication of a type of data for the one or more FL clients to use for the FL job.

38. The method of claim 33, wherein the FL job status information indicates at least one of: a status indicating whether the FL job has been started, paused, resumed, stopped, canceled, or completed.

39. The method of claim 13, wherein the request to create or update the FL job further comprises an indication of a stopping condition for the one or more FL clients to apply when performing one or more FL tasks indicated by the one or more FL task requests.

40. The method of claim 33, wherein the FL task status information comprises an indication of whether one or more FL tasks indicated by the one or more FL task requests were successfully completed.
